(19) United States
(12) Patent Application Publication
(10) Pub. No.: US 2006/0250226 A1
(43) Pub. Date: Nov. 9, 2006

(54) Speed dependent service availability in a motor vehicle

(76) Inventors: Peter Vogel, Hildesheim (DE); Rodolfo Mann Pelz, Hannover (DE)

Correspondence Address: KENYON & KENYON LLP, ONE BROADWAY, NEW YORK, NY, 10004, US

(21) Appl. No.: 10/564,268

(22) PCT Filed: May 13, 2004
(86) PCT No.: PCT/EP04/50783

§ 371 Date: May 18, 2006

(30) Foreign Application Priority Data
Jul. 7, 2003 (DE) 1330613.7

(51) Int. Cl. B60Q 1/00

(52) U.S. Cl. 340/441

(57) ABSTRACT

A method for operating multimedia and/or telematics services and associated user interfaces in a motor vehicle, featuring speed-dependent control of the selection of the services and of the representation of the services at the user interfaces. A speedometer-coupled service management unit controls automatic adaptation of the representation and use of the services in a manner adapted to the instantaneous speed of the motor vehicle. This reduces stress on the driver, the risk of accident, and increases convenience.

### FIELD OF THE INVENTION

The present invention is directed to a method for operating services, in particular multimedia and/or telematics services, in a motor vehicle.

### BACKGROUND INFORMATION

In the following, “services” will be understood to refer to functions and activities which can be invoked locally within a vehicle or also outside the vehicle via a network. The invocation is done by vehicle-borne applications which intend to use the corresponding functions and activities.

In modern motor vehicles, services of the type mentioned at the outset are operated using numerous input control elements as well as a display and loudspeakers as output units. Among the services are local applications or network-bound applications with suitable data transmission. Examples of applications with data transmission to be mentioned include the following services: mobile Internet access, mobile data transmission, push services, context-based services, software download.

Examples of applications running locally, independently of networks, include: navigation, audio and video applications, games, applications for convenience settings, etc.

In the context of the present invention, “user interfaces” are taken to include all user input and output units for the service in question.

The introduction of high-rate, wireless communication methods, such as Global System for Mobile Communications (GSM), Universal Mobile Telecommunications System (UMTS), Wireless Local Area Network (WLAN) and Bluetooth (BT), has made new multimedia services attractive for provision in a motor vehicle. In this connection, the available quality of service (QoS) and data rate of the radio methods mentioned depend substantially on the instantaneous speed of the mobile station (mobile terminal). Thus, for example, the data transfer rate of UMTS in the indoor environment at optimum conditions is less than 2 MBit/s, while in the outdoor environment at speeds above 120 km/h, it is less than 384 kBit/s.

Also important here is the particular available network infrastructure, such as the number and arrangement of mobile radio stations.

However, at higher vehicle speeds, marked limitations in the quality and data transfer rate may occur, so that it is no longer useful to provide certain services. In addition, the higher the speed, the more the driver of the motor vehicle has to concentrate on the traffic, and should not be distracted by complicated control of a user interface. Thus, manual input via a keypad at high speeds involves a high risk of accident because the driver cannot react quickly enough to the sudden appearance of dangerous situations while he/she is concentrating on the keypad.

Also, when driving at high speed, the use of a locally limited communication system, such as a WLAN, can only be useful to a limited extent because the network usage time could then be too short for the service needed.

The related art does not disclose any satisfactory approaches to overcome these shortcomings. At best, it is known to increase the volume of the loudspeakers of a car radio with increasing vehicle speed. However, this is insufficient because the driver is still inundated in an uncontrolled manner with too much information and too difficult ways of input for controlling his/her services, which causes dangerous distraction, especially at high speeds, and results in that many possibilities that can potentially increase the convenience remain unused.

### SUMMARY OF THE INVENTION

Accordingly, this provision includes especially the speed-dependent selection of services from an existing portfolio of services, and the speed-adjusted representation of said services on the output medium, as well as speed-dependent selection of the input and/or output medium, and the adaptation of these media according to speed.

An automatic control increases convenience, reduces stress on the driver, and thus reduces, inter alia, the risk of accident.

An advantageous feature of the inventive measures is the automatic, vehicle-speed dependent selection of a service from the portfolio of multimedia and/or telematics services currently available in the vehicle. This allows services which are not useful or necessary for the particular speed to be suppressed, which right away keeps the driver from selecting such a service, thereby reducing stress on the driver. Thus, in accordance with the present invention, the playback of a video on a screen that the driver can see, for example, is prevented at a speed of 160 km/h.

A further advantageous feature of the inventive control is the selection and/or adaptation of an input medium or an output medium. Thus, for example, at higher speeds, the user interface control can allow only voice commands. Similarly, visual outputs can be simplified or replaced with audibly perceptible outputs at higher speeds. This reduces stress on the driver and, consequently, the risk of accident.

At higher speeds, for example, the information content of a service message can be limited to the most important information, longer pauses between individual messages in message broadcasts, and the form of representation can be adapted to be quickly comprehensible. Distraction of the driver is thereby minimized, thus reducing the risk of accident. The display of colors, graphics and texts, and the arrangement of elements can also be accomplished as a function of the speed.

Moreover, the following inventive measures can be carried out as a function of the speed:

a) changing the character display size on the output medium as long as it makes sense so as not to display too many line breaks;

b) replacing text with graphical information, that is, images or easily comprehensible, preferably internationally used symbols;

c) changing the display color on the output medium with increasing speed, for example, from green via blue to red;

d) prioritizing certain services over other services, for instance, traffic messages over video playback; or

e) controlled selection of advertisements as a function of the speed, for instance, advertisements for luxury goods for fast drivers, etc.

An additional improvement of the present invention is a speed-dependent restriction of the use of communication systems which are only locally available in a useful manner, which prevents selection of a communication system which is useless at the particular speed.

In another advantageous embodiment of the present invention, the inventive control is dependent not only on the speed, but also on the location and/or context of the motor vehicle.

Thus, for instance, within a city, it can be appropriate to suppress too distractive services already at relatively low speeds because of the high volume of traffic occurring there. Also, it may then already be useful to perform an adaptation to simple display representation and simplified control of the user interface. In rental vehicles, the representation can be performed depending on the country in which the vehicle is used.

### BRIEF DESCRIPTION OF THE DRAWINGS

FIG. 1 shows a sketch of an exemplary embodiment of the present inventive system.

FIG. 2 is a flow chart of an exemplary embodiment of the present inventive method.

FIG. 3 shows a sketch of the use of an exemplary embodiment of the present invention in a motor vehicle environment.

### DETAILED DESCRIPTION

In the Figures, like reference numerals designate like or functionally identical components.

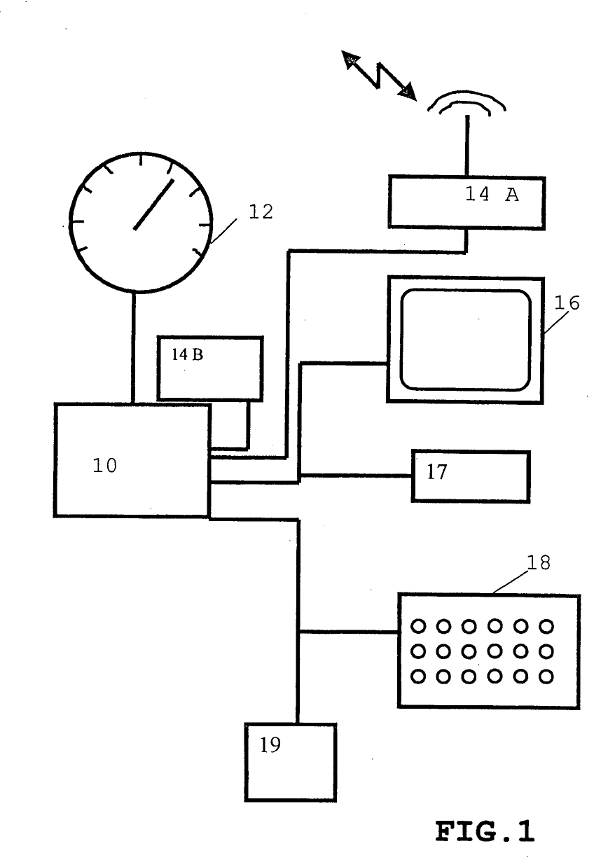

FIG. 1 is a sketch of an exemplary embodiment of the present inventive system. A motor vehicle is provided with a driver information system which is capable of services available to the driver and any passengers present via suitable user interfaces for input, namely a key-based unit 18 and a microphone 19, and for output, namely a display 16 and a loudspeaker 17.

A service 14 A (such as GSM, WLAN, etc.) which can be received via a radio network is symbolically shown connected via suitable interfaces on the part of a control logic 10 provided in accordance with the present invention. A network-independent service 14 B, such as a video player, CD or DVD player, is also connected to control logic 10 via suitable interfaces.

Within the framework of the inventive speed-dependent provision of services, this control logic 10, here referred to as service management unit, can preferably perform two substantially independent processes:

On the one hand, unit 10 controls the speed-dependent adjustment of the above-mentioned user interfaces 16, 17, 18, 19 in the motor vehicle.

On the other hand, it makes a selection between different services or prioritizes certain services over other services as a function of the speed and according to predefined criteria.

Furthermore, service management unit 10 can communicate with a service independently of an input or output, and make a different, (speed-)specific adjustment: For example, it can request up-to-date traffic information for navigation in fast succession when the speed is increased.

Service management unit 10 is connected to speedometer 12 of the motor vehicle to determine the instantaneous vehicle speed. In accordance with the present invention, user interfaces 16, 17, 18, 19 belonging to the particular services requested are then specifically adjusted for said services depending on the magnitude of the speed. The control of services 14 A, B with regard to their selection, as well as the control of the data flow, such as the frequency of requests, or other important parameters for the provision and selection of the services, are also carried out as a function of the speed.

In this context, management unit 10 decides, primarily as a function of the speed, which data and information to display in which way. If necessary, a new speed- or context-adapted representation is selected in the process. Thus, in accordance with the present invention, control logic 10 is used to set parameters that determine which information is provided and displayed to the driver at what time and in which way. This is preferably implemented in a program-controlled manner. For this purpose, central control logic 10 has suitable interfaces to the individual devices, as for example additional connected systems, such as a mobile telephone, a navigation system, a possibly existing universal vehicle server, a video player, etc.

Another special feature is that the display of the service on screen 16 is adapted to the vehicle speed. Thus, for rapid comprehension of information, for example at high speeds, the character size can be increased, and the number of elements displayed can be reduced or varied, or, in a navigation service, arrows can be displayed in place of the map. Another option according to the present invention is to fundamentally change the layout on screen 16, or to replace the display representation with an audible representation, namely a corresponding message.

Moreover, it is advantageously possible to carry out an adaptation of input medium 18, 19 in a manner controlled by the speed, for example as follows: Control elements, in particular keys, can be assigned different functions according to the well-known softkey principle; functions of greater importance being prioritized over those of less importance. In this connection, the issue of the importance of certain functions depends on the service selected.

Furthermore, predetermined functions of associated control elements can be suppressed to simplify input and to help avoid erroneous inputs.

For this purpose, it is also possible to block predetermined keys in an audibly, visually, or tactilely perceptible manner; the perception being aided by a psychologically well-selected feedback, for example, by a suitably preselected, negatively-sounding beep when pressing an unimportant key, or by a corresponding visual signal, for example, by briefly blinking the display twice in a “denial color”, such as red, in response to and giving the impression of a denial, or by lighting up the display once for a slightly longer period of time in a “confirmation color”, such as green, giving the impression of confirmation.

Moreover, it is possible to change the sensitivity or directional characteristics of microphone 19 to allow good resolution of the acoustic signal from the voice of the driver, for example, at a higher speed and a consequently louder noise level.

Furthermore, service management unit 10 can be connected to external terminal devices, such as a mobile telephone unit. In this instance, control unit 10 controls the user input setting as a function of the vehicle speed. One setting would be, for example, that while the vehicle is moving, the mobile telephone unit can only be controlled by voice input. This helps to increase safety during driving because of less distraction of the driver.

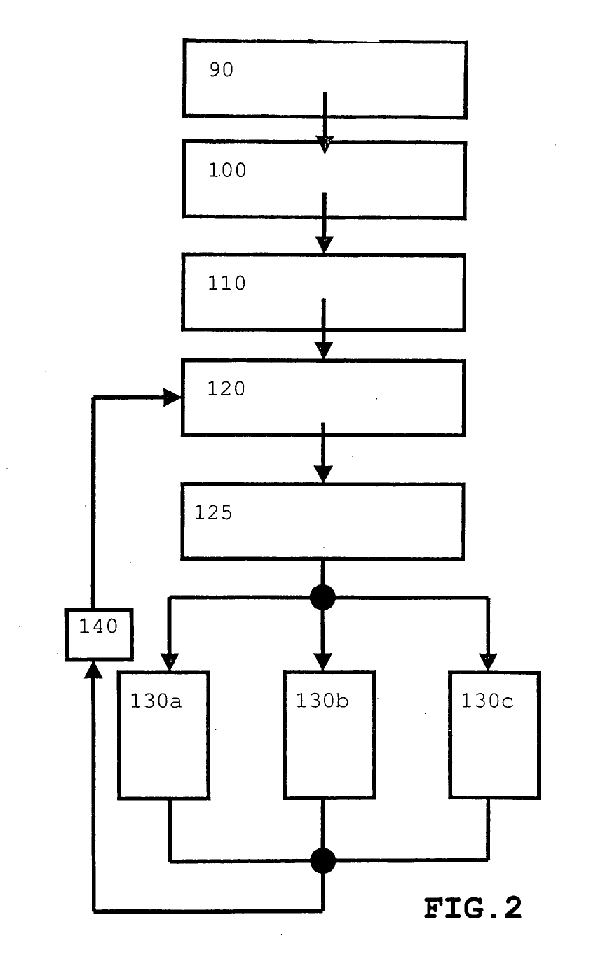

In FIG. 2, a control sequence is shown in a flow chart for an exemplary embodiment of the present inventive method. The description also includes elements from FIG. 1.

In a preliminary step 90, it is determined whether the inventive system is activated, that is, whether it is allowed to intervene in the control of the user interfaces and services. When in an ON-position, the system is activated accordingly. However, it can also be deactivated by the OFF position of a suitable switch, so that a front-seat or other passenger can control the system including all interfaces, and the driver can concentrate entirely on driving. In FIG. 2, only the activated state is shown.

Service data, for example, of a navigation service, which are wirelessly transmitted from outside are received in the motor vehicle, step 100. After a request 110 for the received service by the driver (or in case the driver is already using the service), the speed of the vehicle is determined in step 120. Then, depending on the determined vehicle speed, it is first determined in a step 125 whether or not a selection or prioritization of services should be carried out. If YES, the selection is made, and the particular, speed-adapted service is selected, for example GSM in place of WLAN for speeds above 130 km/h. In the case of NO, the currently proposed service is used.

Thus, in step 125, a selection or prioritization of services is carried out as a function of the speed. The selected services are included into the portfolio of services and are available for output. By assigning a priority, it is possible to determine the sequence in which later output will be performed and in which, for example, computing power is allocated by the system to the service.

Then, in one of the optionally available variants 130a, 130b and 130c, the representation of the service is automatically adapted to the speed.

The example includes three degrees for this purpose, which are exemplified for a single service. The number of setting variants is not fixed to three; rather, a smaller or greater number of setting variants may exist specifically for the particular service requested. For example, a suitable sensor system can provide a further level which is activated when the vehicle does not move for more than 5 seconds. In the embodiment shown in FIG. 2, variant 130a is automatically selected when the speed is below 50 km/h. In this case, the navigation service is presented to the driver on screen 16 in the form of a map.

Variant 130b is used in the speed range from 50 to 130 km/h. Then, representation is no longer in the form of a map, but limited to arrows indicating turns.

Variant 130c is selected for a vehicle speed greater than 130 km/h. In this case, the display of the navigation service is completely suppressed and, optionally, it is indicated that the service is currently not available to the driver. Instead, there is only audible output.

Depending on the type of service, other speed limits and other settings of the particular user interface 16, 17, 18, 19 may exist. Thus, for example, the input type setting of a mobile telephone would only be “voice” above 0 km/h, except for stationary or parked vehicles, and above 130 km/h, input would be completely blocked.

When the setting of the user interfaces is completed and the services is or is not displayed accordingly, a wait loop of a certain duration, such as five seconds, is entered in step 140. After that, the speed is checked again in step 120 and, if necessary, a different setting is made according to steps 125, 130a, 130b and 130c. This method is then continued in the loop.

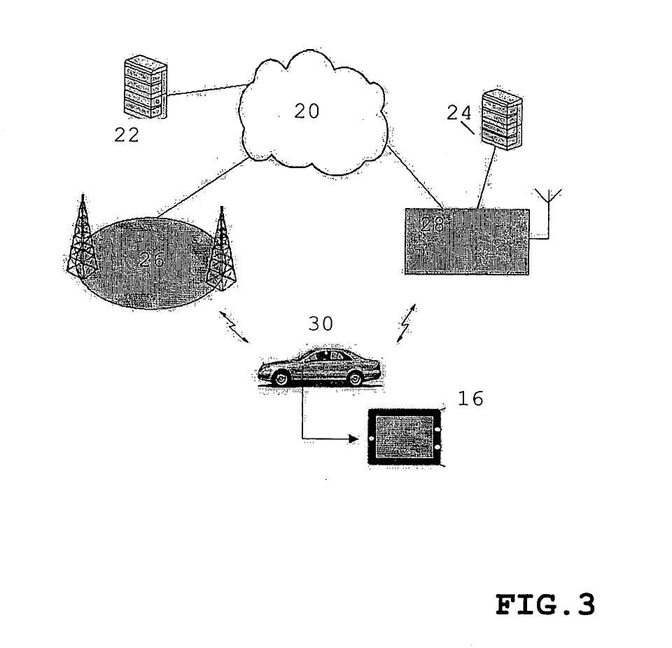

FIG. 3 is a sketch of the use of an exemplary embodiment of the present invention in a motor vehicle environment.

A motor vehicle 30 equipped with an embodiment of present inventive system is located in the service area of two wireless communication networks 26, 28. The use of the one network 26 is not locally limited. The network in question may be a UMTS or GSM network. In contrast, the other communication network 28 is locally limited within narrow bounds, such as a WLAN. Both communication networks 26, 28 communicate with the Internet 20, to which a service provider 22 is connected, for example, a service provider for software download. In contrast, another software download service 24 of better quality can only be reached via the locally limited WLAN 28. However, above a certain speed of motor vehicle 30, such as 30 km/h, it is no longer useful to attempt connection via WLAN 28, because the dwell time within the available coverage area of the base station is too short. Consequently, the use of an existing WLAN 28 is advantageous for lower speeds and standing vehicles. A mobile radio network 26 can be used especially when WLAN 28 is not available, or when the speed is too high. The embodiment of the present inventive system makes the proper selection automatically. The content transmitted by the selected service provider 22, 24 is then displayed to the driver on screen 16.

The present invention can also be embedded in a computer program product, which includes all the features enabling the implementation of the methods described herein, and which—when loaded in a computer system in the motor vehicle and fed with current data—is able to carry out these methods.

The present invention also provides for a service management control logic in the form of a programmed interface module, which contains the bus interfaces of the individual (multimedia) devices and includes the control line to the speedometer or another device for measuring the vehicle speed. This also allows integration of individual, non-integrated systems into the speed-dependent control. Thus, a control without an integrated driver information system is possible as well. The terminal devices are preferably controlled via standard interfaces. These can be, for example, bus systems (such as CAN, MOST, IEEE 1394) or direct cable connections if no bus connection exists.

In the present context, computer program products or computer programs are understood to mean any expression, in any language, code or notation, of a set of instructions whose purpose is to cause a system capable of processing information to carry out, either directly or successively, one particular or both of the following tasks:

conversion into a different language or notation, or into a different code,

reproduction into a different material form.

Although the present invention has been described above with reference to a preferred exemplary embodiment, it is not limited thereto but can be modified in many ways.

Thus, for example, the illumination intensity of the display for displaying the service can also be controlled via the service management element as a function of the speed.

1.-13. (canceled)

14. A method for operating multimedia and/or telematics services in a motor vehicle, comprising:
providing the services in a speed-dependent manner.

15. The method as recited in claim 14, wherein:
the providing of the services includes at least one of a control of a selection of the services and a representation of the services on a user interface present in the motor vehicle.

16. The method as recited in claim 14, wherein the selection of the services includes a prioritization of predetermined services over other services that are also available.

17. The method as recited in claim 14, further comprising:
performing a speed-dependent selection of an input medium for an operator control of the services.

18. The method as recited in claim 14, further comprising:
performing a speed-dependent selection of an output medium for a representation of the services.

19. The method as recited in claim 14, further comprising:
performing a speed-dependent adaptation of at least one of an input medium and an output medium.

20. The method as recited in claim 14, further comprising:
performing a control involving a selection of a suitable form of representation of contents provided by the particular service on an output medium.

21. The method as recited in claim 14, further comprising:
adapting an output medium in a manner controlled by a speed by performing at least one of the following:
a) changing a character display size on the output medium,
b) replacing text with graphical information,
c) changing a display color on the output medium, and
d) providing a controlled selection of advertisements as a function of the speed.

22. The method as recited in claim 19, further comprising:
performing one of the following for adapting an input medium in a manner controlled by a speed:
a) assigning control elements, including keys, different functions, in which functions of greater importance being prioritized over those of less importance,
b) suppressing predetermined functions of predefined associated control elements,
c) blocking keys in one of an audibly perceptible manner, a visually perceptible manner, and a tactilely perceptible manner, and
d) changing one of a sensitivity characteristic of a microphone and a directional characteristic of the microphone.

23. The method as recited in claim 14, further comprising:
selecting a transmission medium for communication and setting corresponding service parameters as a function of a speed.

24. The method as recited in claim 14, further comprising:
performing a control in at least one of a location-dependent manner and a context-dependent manner.

25. A vehicle information system for operating services including at least one of multimedia services and telematics services and associated user interfaces in a motor vehicle, comprising:
a service management unit connectable to:
a) a device for one of measuring and displaying an instantaneous vehicle speed, and
b) a user interface for providing the services in a speed-dependent manner.

26. A service management unit for use in an operation of multimedia and/or telematics services and associated user interfaces, in a motor vehicle, comprising:
a control unit for analyzing information on a vehicle speed and being configured to providing the services in a speed-dependent manner.
